(19) United States
(12) Patent Application Publication
(10) Pub. No.: US 2026/0344817 A1
(43) Pub. Date: Nov. 5, 2026

(54) A SMART HELMET TO CAPTURE, DETECT, AND COMMUNICATE AN IMPACT AND A METHOD THEREOF

(71) Applicant: Sreenivas Kameswar Mangipudi, Hyderabad (IN)

(72) Inventor: Sreenivas Kameswar Mangipudi, Hyderabad (IN)

(21) Appl. No.: 18/700,873

(22) PCT Filed: Mar. 11, 2024
(86) PCT No.: PCT/IB2024/052318

§ 371 Date: Apr. 12, 2024

(30) Foreign Application Priority Data
Jan. 16, 2024 (IN) 202441003166

(51) Int. Cl. A42B 3/04; H04W 4/38; H04W 4/44; H04W 4/90

(52) U.S. Cl. CPC A42B 3/046; H04W 4/38; H04W 4/44; H04W 4/90

(57) ABSTRACT

A smart helmet to capture, detect, and communicate an impact is disclosed. The smart helmet includes a receiving unit to receive data in real-time from sensors of an impact on the smart helmet. The smart helmet includes an analyzing unit to interpret the data to measuring the force of the impact and analyze historical data to generate insights pertaining to the user's safety and training. A tracking unit to detect an accurate location of the user via a plurality of satellite units. A communication unit to send an alert about the impact to predetermined contacts. A cloud connectivity unit to store the data of the impact thereby allowing authorized users to access the data to understand the patterns and diagnose potential injuries. A battery unit to avoid a potential damage during the impact thereby protecting against short circuits.

### EARLIEST PRIORITY DATE

This Application claims priority from a complete patent application filed in India having Patent Application No. 202441003166, filed on 16th day of January 2024 and titled “A SMART HELMET TO CAPTURE, DETECT, AND COMMUNICATE AN IMPACT AND A METHOD THEREOF” and a PCT Application no. PCT/IB2024/052318 filed on Mar. 11, 2024, and titled “A SMART HELMET TO CAPTURE, DETECT, AND COMMUNICATE AN IMPACT AND A METHOD THEREOF.”

### FIELD OF INVENTION

Embodiments of the present disclosure relate to the field of helmets, and more particularly, a smart helmet to capture, detect, and communicate an impact and a method thereof.

### BACKGROUND

The use of helmets is common and crucial for personal safety while riding a vehicle. The helmets are intended to protect a user's head from head injuries during several activities (such as riding a bicycle, motorcycle, skiing, skating or any other mode of transportation). Typically, the necessity of using helmets is beyond legal requirements. Currently, the helmets are tailored with various designs and features to meet specific risks associated with an activity or environment. Further, the use of various materials in the helmets are subjected to degradation that may compromise protective capabilities. To maximize lifespan of the helmet and ensure its effectiveness, the choice of materials is crucial to ensure the helmet's effectiveness in absorbing and dissipating impact energy. A combination of the materials in various layers supports to meet safety standards and provide effective protection against impacts. However, the materials may deteriorate over time, potentially compromising protective capabilities. Further, the users lack a method to measure deterioration or recognize the potential decreased efficacy.

Furthermore, the helmets fail to provide real-time or post-impact data regarding the nature and severity of an impact encountered during the activity. This lack of data for medical professionals leaves uncertainty about potential severity of injuries and suitable intervention strategies. Moreover, delays in notifying emergency services or loved ones about accidents, particularly those involving solitary riders or participants, may increase risks and may worsen injuries.

Hence, there is a need for an improved smart helmet to capture, detect, and communicate an impact and a method thereof which addresses the aforementioned issue(s).

### OBJECTIVE OF THE INVENTION

An objective of the invention is to capture critical data of occurrence of an impact in real-time.

Yet another objective of the invention is to measure the force, duration and angle of the impact thereby facilitating a detailed analysis of potential injuries.

Yet another objective of the invention is to track a location of the user using a plurality of satellite units to send out alerts to specific contacts, thereby reducing the time between an accident and the arrival of assistance.

### BRIEF DESCRIPTION

In accordance with an embodiment of the present disclosure, a smart helmet to capture, detect, and communicate an impact is provided. The smart helmet includes a processing subsystem hosted on a server. The processing subsystem is configured to execute on a network to control bidirectional communications among a plurality of modules. The smart helmet includes a receiving unit configured to receive data of impact in real-time from a plurality of sensors in response to an impact experienced on the smart helmet utilized by a user of a vehicle. The plurality of sensors are positioned at a predetermined distance inside the smart helmet to measure force, direction, and angle of the impact to facilitate analysis of a plurality of potential injuries to the user. The plurality of sensors are configured to communicate the data to one or more authorized users in real-time. The smart helmet includes an analyzing unit operatively coupled to the receiving unit wherein the analyzing unit is configured to interpret the data of the impact by creating a plurality of patterns to diagnosing injuries from the data of impact thereby measuring the force of the impact. The analyzing unit is also configured to analyze historical data to generate insights pertaining to the user's safety and training. Further, the smart helmet includes a tracking unit operatively coupled to the analyzing unit wherein the tracking unit is configured to detect an accurate location of the user via a plurality of satellite units. The smart helmet also includes a communication unit operatively coupled to the tracking unit wherein the communication unit is configured to send an alert about the impact to one or more predetermined contacts of the user. Furthermore, the smart helmet also includes a cloud connectivity unit operatively coupled to the communication unit wherein the cloud connectivity unit is configured to store the data of the impact in a cloud thereby allowing one or more authorized users to access the data of the impact to understand the patterns and diagnose potential injuries. Further, the smart helmet includes a battery unit operatively coupled to the cloud connectivity unit wherein the battery unit is adapted to avoid a potential damage during the impact thereby protecting against short circuits.

In accordance with another embodiment of the present disclosure, a method to operate a smart helmet to capture, detect, and communicate an impact is provided. The method includes receiving, by a receiving unit, data of an impact in real-time from a plurality of sensors in response to an impact experienced on the smart helmet utilized by a user of a vehicle. The plurality of sensors are positioned at a predetermined distance inside the smart helmet to measure force, direction, and angle of the impact to facilitate analysis of a plurality of potential injuries to the user. Further, the plurality of sensors are configured to communicate the data to one or more authorized users in real-time. The method also includes interpreting, by an analyzing unit, the data of the impact by creating a plurality of patterns to diagnosing injuries from the data of impact thereby measuring the force of the impact. The method includes analyzing, by the analyzing unit, a historical data to generate insights pertaining to the user's safety and training. The method includes detecting, by a tracking unit, an accurate location of the user via a plurality of satellite units. Further, the method includes sending, by a communication unit, an alert about the impact to one or more predetermined contacts of the user. Furthermore, the method includes storing, by a cloud connectivity unit, the data of the impact thereby allowing one or more authorized users to access the data of the impact to understand the patterns and diagnose potential injuries. Moreover, the method includes adapting, by a battery unit, to avoid a potential damage to the battery unit during the impact thereby protecting against short circuits.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

The disclosure will be described and explained with additional specificity and detail with the accompanying figures in which:

FIG. 1 is a schematic representation of a smart helmet to capture, detect and communicate an impact in accordance with an embodiment of the present disclosure;

FIG. 2 is a block diagram representation of the smart helmet to capture, detect, and communicate an impact of FIG. 1 in accordance with an embodiment of the present disclosure;

FIG. 3 is a block diagram representation of a smart helmet to capture, detect, and communicate an impact of FIG. 1 in accordance with another embodiment of the present disclosure;

FIG. 4 is a block diagram of representation of an exemplary embodiment of a smart helmet to capture, detect, and communicate an impact in a real-time scenario of FIG. 1 in accordance with yet another embodiment of the present disclosure;

FIG. 5 is a block diagram of a computer or a server in accordance with an embodiment of the present disclosure; and

FIG. 6 illustrates a flow chart representing the steps involved in a method to operate the smart helmet to capture, detect and communicate an impact in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or subsystems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

Embodiments of the present disclosure relate to a smart helmet to capture, detect, and communicate an impact is provided. The smart helmet includes a processing subsystem hosted on a server. The processing subsystem is configured to execute on a network to control bidirectional communications among a plurality of modules. The smart helmet includes a receiving unit configured to receive data of impact in real-time from a plurality of sensors in response to an impact experienced on the smart helmet utilized by a user of a vehicle. The plurality of sensors are positioned at a predetermined distance inside the smart helmet to measure force, direction, and angle of the impact to facilitate analysis of a plurality of potential injuries to the user. The plurality of sensors are configured to communicate the data to one or more authorized users in real-time. The smart helmet includes an analyzing unit operatively coupled to the receiving unit wherein the analyzing unit is configured to interpret the data of the impact by creating a plurality of patterns to diagnosing injuries from the data of impact thereby measuring the force of the impact. The analyzing unit is also configured to analyze historical data to generate insights pertaining to the user's safety and training. Further, the smart helmet includes a tracking unit operatively coupled to the analyzing unit wherein the tracking unit is configured to detect an accurate location of the user via a plurality of satellite units. The smart helmet also includes a communication unit operatively coupled to the tracking unit wherein the communication unit is configured to send an alert about the impact to one or more predetermined contacts of the user. Furthermore, the smart helmet also includes a cloud connectivity unit operatively coupled to the communication unit wherein the cloud connectivity unit is configured to store the data of the impact in a cloud thereby allowing one or more authorized users to access the data of the impact to understand the patterns and diagnose potential injuries. Further, the smart helmet includes a battery unit operatively coupled to the cloud connectivity unit wherein the battery unit is adapted to avoid a potential damage during the impact thereby protecting against short circuits.

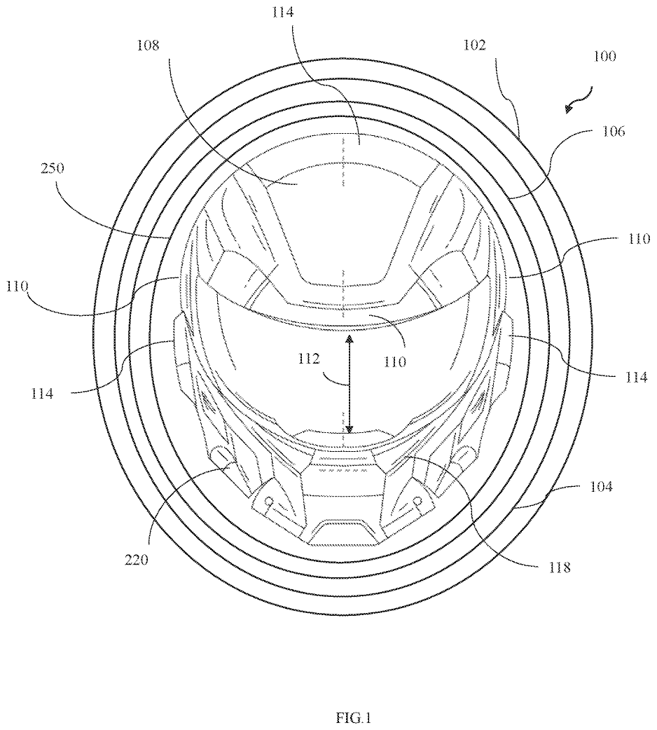

FIG. 1 is a pictorial representation of a smart helmet to capture, detect and communicate an impact in accordance with an embodiment of the present disclosure. The smart helmet 100 includes a plurality of sensors 102, 104, 106, 108, a plurality of cameras 110, an augmented reality visor 112, a plurality of solar voltaic cells 114, a communication unit 220, a smart clothing 118 and a feedback unit 250.

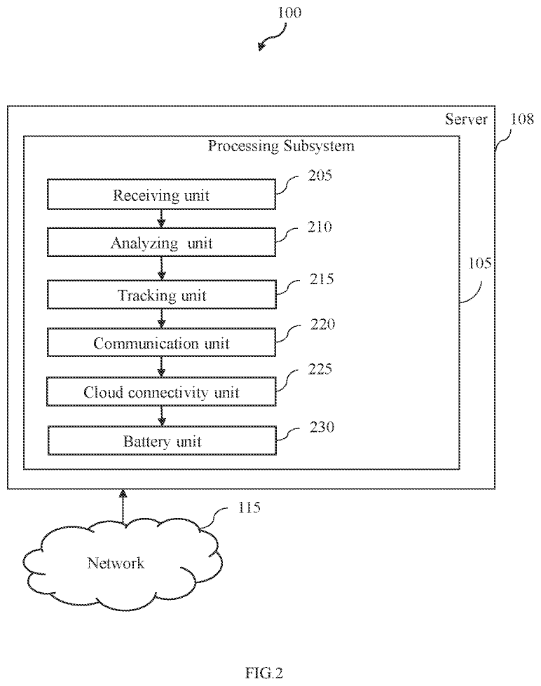

The plurality of sensors 102, 104, 106, 108, includes an environmental sensor 102, a piezoelectric sensor 104, an accelerometer sensor 106 and a biometric sensor 108. The environmental sensor 102, the piezoelectric sensor 104 and the accelerometer sensor 106 are positioned along the circumference of the smart helmet 100 in a sequential layer. The functionality of the plurality of sensors is further discussed in FIG. 2.

The plurality of cameras 110 are positioned in a front end, right end, left end and right end of the smart helmet 100. It must be noted that the plurality of cameras 110 are integrated for 360 degree coverage. Further, the plurality of cameras 110 are adapted to capture or record data pertaining to the impact and the user's surrounding. This data is essential for post-incident analysis, insurance claims and understanding the context of accidents or impacts. The augmented reality visor 112 positioned in the front end of the smart helmet 100. Further, the augmented reality visor 112 provides a heads-up display (HUD) that provides real-time information overlays such as navigation, hazard alerts and environment data. This enhances the riding experience by integrating digital data into the user's field of view, improving awareness and decision-making. The solar photo voltaic cells 114 are positioned in a top, left side and right side of the smart helmet 100. The communication unit 220 is positioned at lower backside of the smart helmet 100.

The feedback unit 250 is positioned within an interior lining, integrated within the smart helmet's padding, straps, and areas in contact with the user's head. In one embodiment, the smart helmet 100 may connect with a smart clothing worn by the user seamlessly. The smart helmet is designed to integrate with smart clothing using technologies like near-field communication (NFC), Bluetooth, and wireless fidelity (Wi-Fi) direct thereby enhancing safety and situational awareness by enabling helmet-to-garment communication and data exchange. The NFC initiates instant helmet to garment connection, the Bluetooth monitors vital signs and environmental factors, and the Wi-Fi Direct allows high-volume data transfers. Interconnected ecosystem offers a comprehensive, real-time overview of users' physical state and surroundings, marking a significant advancement in personal safety technology.

Typically, the feedback unit 250 provides an intuitive, non-visual communication cues to the user based on the data received from the plurality of sensors or connected user devices thereby enhancing the interaction with the smart helmet 100 and connected smart clothing worn by the user. Consequently, safety and user experience are enhanced. Further, a unified control and monitoring of connected wearables (for instance, jackets with LED lights or temperature-regulating fabrics is achieved.

FIG. 2 is a block diagram of a smart helmet to capture, detect, and communicate an impact of FIG. 1 in accordance with an embodiment of the present disclosure. The smart helmet 100 includes a processing subsystem 105 hosted on a server 108. In one embodiment, the server 108 may include a cloud-based server. In another embodiment, parts of the server 108 may be a local server coupled to a user device (not shown in FIG. 1). The processing subsystem 105 is configured to execute on a network 115 to control bidirectional communications among a plurality of modules. In one example, the network 115 may be a private or public local area network (LAN) or Wide Area Network (WAN), such as the Internet. In another embodiment, the network 115 may include both wired and wireless communications according to one or more standards and/or via one or more transport mediums. In one example, the network 115 may include wireless communications according to one of the 802.11 or Bluetooth specification sets, or another standard or proprietary wireless communication protocol. In yet another embodiment, the network 115 may also include communications over a terrestrial cellular network, including, a global system for mobile communications (GSM), code division multiple access (CDMA), and/or enhanced data for global evolution (EDGE) network.

The processing subsystem 105 includes a receiving unit 205 configured to receive real-time data of impact from a plurality of sensors in response to an impact experienced on the smart helmet 100 utilized by a user of a vehicle. Typically, the impact refers to forceful collision or contact between objects, often vehicles in traffic accidents. Examples of the impact includes, an accident leading to an emergency and minor impacts (for instance, sports training, recreational activities, day-to-day use and feeding data for analysis and insights). The severity of impact depends on vehicle speed, collision angle, and vehicle size and weight, affecting the severity of the accident. As used herein, the real-time data refers to the data captured during the occurrence of the impact. The plurality of sensors (as shown in FIG. 1) are positioned at a predetermined distance inside the smart helmet to measure force, direction, and angle of the impact to facilitate analysis of a plurality of potential injuries to the user. As used herein, the force is the impact force generated during a collision between objects or vehicles. The direction is the impact direction refers to path of movement of the objects involved, typically vehicles, at the time of impact, that may significantly influence the severity of injury. The angle of collision refers to the angle between the paths of the collision vehicles at the time of impact.

The plurality of sensors are configured to communicate the data to one or more authorized users in real-time. The piezoelectric sensor 104 is configured to detect the force and direction of the impact on the smart helmet 100. The piezoelectric sensor 104 utilizes the piezoelectric effect to measure changes in pressure, acceleration, temperature, or force by converting them into electrical charges. The material used in piezoelectric sensor 104 generate an electrical charge in response to mechanical stress, allowing for precise measurement of impact forces, which is vital for assessing potential injuries and helmet integrity. The accelerometer sensor 106 is configured to measure dynamics of the impact via multiple parameters. The parameters may include a rate of change in velocity and a plurality of acceleration forces during the impact. The accelerometer sensor 106 measures acceleration of an object, excluding gravity, by observing rate of change in velocity relative to mass-free fall. The biometric sensor 108 is configured to detect a plurality of physiological parameters of the user. Examples of the physiological parameters includes, but is not limited to heart rate, stress levels, and potentially blood oxygen levels. The biometric sensor 108 provides health information to the user thereby alerting the user about physiological anomalies or distress, which is essential for safety during riding or sports activities. The environmental sensor 102 is configured to detect a plurality of external factors and subsequently provides real time updates to the user. Examples of external factors include, but are not limited to, air quality, UV radiation, and weather conditions. The environmental sensor 102 provides real-time updates to the wearer, enhancing situational awareness and promoting health by alerting to potentially harmful environmental conditions. The smart helmet 100 includes integrated solar photovoltaic cells 114 configured to allow the smart helmet 100 to self-charge using solar energy. This ensures that the smart helmet's 100 electronic components are powered continuously, enhancing energy efficiency and sustainability. The solar photovoltaic cells 114 are discreetly incorporated without compromising on the aesthetics of the smart helmet 100. Further, the smart helmet 100 includes an augmented reality visor 112 configured to integrate real-time information on a display within the user's field of view thereby enhancing a riding experience.

Further, the smart helmet 100 includes an analyzing unit 210 operatively coupled to the receiving unit 205. The analyzing unit 210 is configured to interpret the data of the impact by creating a plurality of patterns to diagnose injuries from the data of impact thereby measuring the force of the impact. Typically, the patterns in analysis refer to recurring themes, trends, or regularities observed in data of the impact. The patterns are frequently identified through statistical methods, visualizations, and machine learning algorithms, such as trend analysis, clustering, and classification.

In one embodiment, the analyzing unit 210 provides insights for milder impacts, and offers feedback for training in sports, recreational, and industrial contexts requiring helmet use as protective gear.

Additionally, the analyzing unit 210 is configured to analyze historical data to generate insights pertaining to the user's safety and training.

Further, the smart helmet includes a tracking unit 215 operatively coupled to the analyzing unit 210. The tracking unit 215 is configured to detect an accurate location of the user via a plurality of satellite units. For instance, GPS is a satellite-based navigation system consisting of a constellation of medium Earth orbit satellites that transmit precise signals to Earth's GPS receivers thereby calculating a user location by triangulating signals from multiple satellites.

In one embodiment, artificial intelligence techniques and machine learning techniques are configured in the smart helmet 100 for predictive analysis of environmental hazards, wearer behavior and hazard prediction. The training data utilized for the performance of the intelligence techniques and machine learning techniques includes the historical data of previous impacts.

The smart helmet 100 also includes a communication unit 220 operatively coupled to the tracking unit 215. The communication unit 220 is configured to send an alert to one or more predetermined contacts of the user. In one embodiment, the alert may be via text messages or voice messages. The predetermined contacts may include loved ones, emergency services, personal care takers and medical professionals. Further, the alert notifies the predetermined contacts of an accident encountered by the user. Typically, the communication unit 220 may include an embedded Subscriber Identity module (SIM) or a Global Positioning System (GPS) to send the alert to the predetermined contacts when the impact is detected.

In one embodiment, the communication unit 220 is configured to allow communication between multiple smart helmets and vehicle-to-everything (V2X) for enhanced safety, collision avoidance and situational awareness. Mesh network facilitates communication between multiple helmets and the vehicle-to-everything. The mesh network is a decentralized topology in which each node is linked to every other node. The node as used herein, includes but is not limited to the helmet, predetermined contacts, and a plurality of sensors. The vehicle-to-everything (V2X) is a technology that facilitates communication between vehicles and environment through multiple methods such as vehicle-to-vehicle, vehicle-to-infrastructure, vehicle-to-pedestrian, and vehicle-to-grid. The ‘X’ as used herein refers to vehicle, infrastructure, pedestrian, and grid. Fifth-generation technology may be utilized for data transmission from vehicle-to-everything (V2X). The smart helmet also includes a cloud connectivity unit 225 operatively coupled to the communication unit 220. The cloud connectivity unit 225 is configured to store the data of the impact thereby allowing the authorized users to access the data of the impact by scanning a quick response code. The authorized users may be medical professionals. The QR code allows bystanders and first responders without specialized equipment to quickly understand incidents and access stored medical data, expediting life-saving measures. The quick response (QR) code links to the smart helmet an agnostic application facilitating data retrieval and emergency response. The QR codes are two-dimensional barcodes consisting of black squares on a white grid, designed for quick and easy scanning by imaging devices like smartphones, tablets, or dedicated QR code scanners. Typically, the cloud connectivity unit 225 synchronizes with a cloud storage to ensure data backup and accessibility.

Furthermore, the smart helmet 100 includes a battery unit 230 operatively coupled to the cloud connectivity unit 225. The battery unit 230 is adapted to prevent damage to the battery unit 230 during the impact thereby protecting against short circuits.

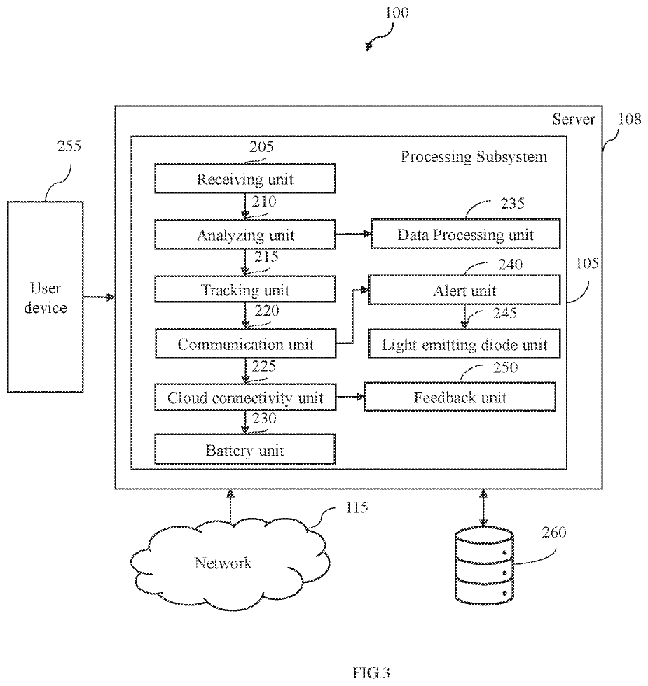

FIG. 3 is a block diagram representation of a smart helmet to capture, detect, and communicate an impact of FIG. 1 in accordance with an embodiment of the present disclosure. The smart helmet 100 includes an alert unit 240 operatively coupled to the communication unit 220. The alert unit 240 is configured to notify the user upon detecting material degradation of the smart helmet 100. The material degradation is identified using a plurality of techniques. The smart helmet 100 is made from materials designed to protect the user head. Examples of the materials used in the smart helmet includes, but is not limited to, polycarbonate, expanded polystyrene, fiberglass, Kevlar, and carbon fiber.

The smart helmet also includes a light emitting diode unit 245 operatively coupled to the alert unit 240. The light emitting diode unit 245 is configured to indicate status of battery health, connectivity, and system malfunction. Typically, the light emitting diode unit 245 is a semiconductor device that emits light when an electric current passes through the semiconductor device. The smart helmet 100 also includes a data processing unit 235 operatively coupled to the battery unit 230. The data processing unit 235 is configured to determine severity and potential consequences of the impact. The severity of the impact is determined by a predefined threshold value. The predefined threshold value may be determined by a user upon wearing the smart helmet 100 via predetermined techniques.

Further, the smart helmet 100 also includes a feedback unit 250 operatively coupled to the cloud connectivity unit 225. The feedback unit 250 is configured to provide tactile sensations to the user in response to one or more notifications and alert. The feedback unit 250 is also configured to analyze historical data and real-time data of the impact from the cloud connectivity unit 225 to generate potential insights using artificial intelligence techniques as feedback pertaining to the user's safety measures. The historical data is the data collected from the plurality of sensors.

Further, the smart helmet 100 is connected to a user device 255 operated by the user. It is to be noted that the user device 255 may comprise, but is not limited to, a mobile phone, desktop computer, portable digital assistant (PDA), smart phone, tablet, ultra-book, netbook, laptop, multi-processor system, microprocessor-based or programmable consumer electronic system, or any other communication device that a user may use. In some embodiments, the system may comprise a display module (not shown) to display information (for example, in the form of user interfaces). In further embodiments, the system may comprise one or more of touch screens, accelerometers, gyroscopes, cameras, microphones, global positioning system (GPS) devices, and so forth.

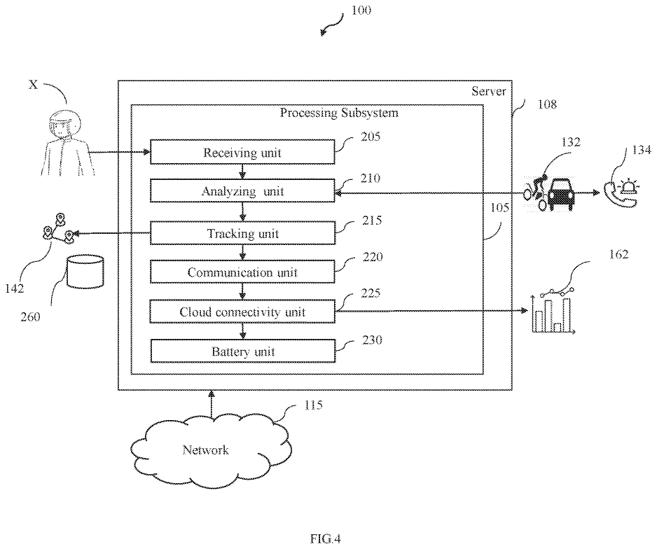

FIG. 4 is a block diagram of representation of an exemplary embodiment of a smart helmet to capture, detect, and communicate an impact in a real-time scenario of FIG. 1 in accordance with another embodiment of the present disclosure. Consider a scenario where user ‘X’ wears a smart helmet 100 and engages in riding a vehicle from a source A to a destination B. An augmented reality visor integrated into the smart helmet 100 provides the user with real-time navigation, environmental data and interactive functionalities for enhanced user experience. During the travel, user ‘X’ meets with an accident. The plurality of sensors integrated in the smart helmet 100 captures the impact 132 of the accident in real time and measures the force, direction and angle of the impact 132. The data is then transmitted to a receiving unit 205. Additionally, the data is communicated to one or more authorized users in real-time. An accurate location 142 of the user ‘X’ is tracked via a plurality of satellite units. The data of the impact is stored in a database 260 via a cloud connectivity unit 225 thereby authorized users may access the data whenever required by scanning a QR code. Consequently, the QR code redirects the user to the agnostic application configured on his/her user device 255 and allows the user to view the data of the impact. Upon storing the data of the impact, an analyzing unit 210 generate patterns 162 pertaining to the potential injuries of the user ‘X’. An alert 134 is sent to one or more predetermined contacts upon occurrence of the impact via a communication unit 220. As a result, the time between an accident and the arrival of assistance is reduced significantly.

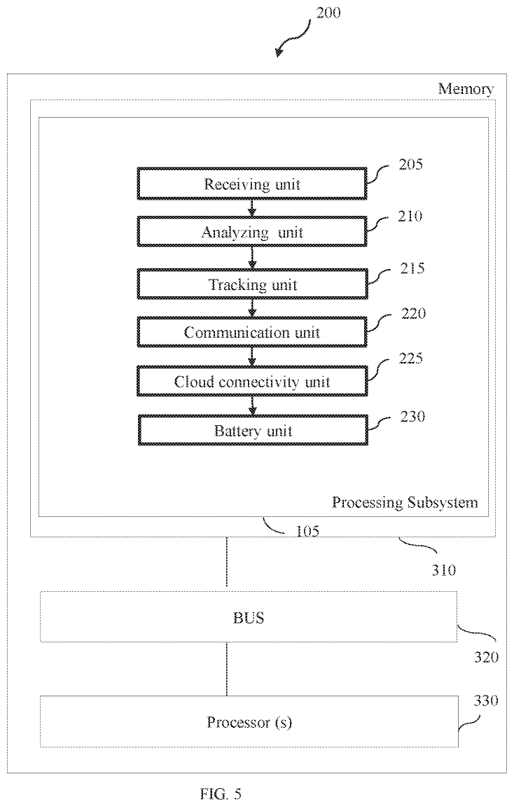

FIG. 5 is a block diagram of a computer or a server in accordance with an embodiment of the present disclosure. The server 108 includes processor(s) 330, and memory 310 operatively coupled to the bus 320. The processor(s) 330, as used herein, means any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a digital signal processor, or any other type of processing circuit, or a combination thereof.

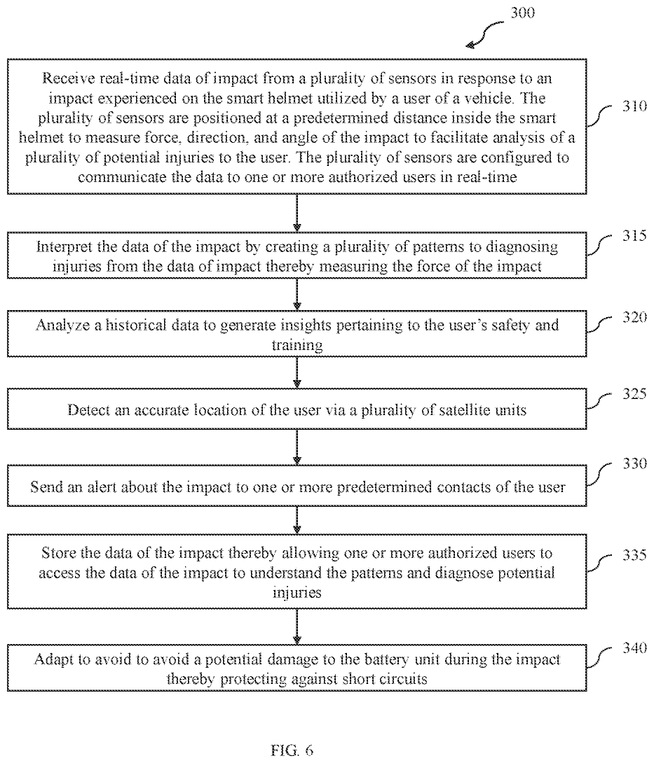

The memory 310 includes several subsystems stored in the form of executable program which instructs the processor 330 to perform the method steps illustrated in FIG. 6. The memory 310 includes a processing subsystem 105 of FIG. 1. The processing subsystem 105 further has following modules: a receiving unit 205, a communication unit 220, a tracking unit 215, a cloud connectivity unit 225, an analyzing unit 210 and a battery unit 230.

In accordance with an embodiment of the present disclosure, a smart helmet to capture, detect, and communicate an impact is provided. The smart helmet 100 includes a processing subsystem 105 hosted on a server 108. The processing subsystem 105 is configured to execute on a network 115 to control bidirectional communications among a plurality of modules. The smart helmet 100 includes a receiving unit 205 configured to receive data of impact in real-time from a plurality of sensors in response to an impact experienced on the smart helmet utilized by a user of a vehicle. The plurality of sensors are positioned at a predetermined distance inside the smart helmet to measure force, direction, and angle of the impact to facilitate analysis of a plurality of potential injuries to the user. The plurality of sensors are configured to communicate the data to one or more authorized users in real-time. The smart helmet 100 includes an analyzing unit 210 operatively coupled to the receiving unit 205 wherein the analyzing unit 210 is configured to interpret the data of the impact by creating a plurality of patterns to diagnosing injuries from the data of impact thereby measuring the force of the impact. The analyzing unit 210 is also configured to analyze historical data to generate insights pertaining to the user's safety and training. Further, the smart helmet 100 includes a tracking unit 215 operatively coupled to the analyzing unit 210 wherein the tracking unit 215 is configured to detect an accurate location of the user via a plurality of satellite units. The smart helmet 100 also includes a communication unit 220 operatively coupled to the tracking unit 215 wherein the communication unit 220 is configured to send an alert about the impact to one or more predetermined contacts of the user. Furthermore, the smart helmet 100 also includes a cloud connectivity unit 225 operatively coupled to the communication unit 220 wherein the cloud connectivity unit 225 is configured to store the data of the impact in a cloud thereby allowing one or more authorized users to access the data of the impact to understand the patterns and diagnose potential injuries. Further, the smart helmet 100 includes a battery unit 230 operatively coupled to the cloud connectivity unit 225 wherein the battery unit 230 is adapted to avoid a potential damage during the impact thereby protecting against short circuits.

The bus 320 as used herein refers to internal memory channels or computer network that is used to connect computer components and transfer data between them. The bus 320 includes a serial bus or a parallel bus, wherein the serial bus transmits data in bit-serial format and the parallel bus transmits data across multiple wires. The bus 320 as used herein may include but not limited to, a system bus, an internal bus, an external bus, an expansion bus, a frontside bus, a backside bus and the like.

FIG. 6 illustrates a flow chart representing a method 300 to operate a smart helmet to capture, detect, and communicate an impact in accordance with an embodiment of the present disclosure. The method 300 includes receiving, by a receiving unit 205, real-time data of impact from a plurality of sensors in response to an impact experienced on the smart helmet utilized by a user of a vehicle in step 310. The plurality of sensors are positioned at a predetermined distance inside the smart helmet to measure force, direction, and angle of the impact to facilitate analysis of a plurality of potential injuries to the user. The plurality of sensors are configured to communicate the data to one or more authorized users in real-time.

The plurality of sensors includes an environmental sensor, a piezoelectric sensor, an accelerometer sensor and a biometric sensor. The environmental sensor is configured to detect a plurality of external factors and subsequently provide real-time updates to the user. The piezoelectric sensor is configured to detect the force and direction of the impact. The accelerometer sensor is configured to measure the dynamics of the impact via multiple parameters, wherein the parameters comprises a rate of change in velocity and a plurality of acceleration forces during the impact. The biometric sensor is configured to detect a plurality of physiological parameters of the user pertaining to health information of the user.

In one embodiment, the method 300 includes enabling a user profile management for providing medical and personal data to be used during emergency situations.

Additionally, the method 300 includes capturing, by a plurality of cameras, the impact and an environment enclosing the occurrence of the impact.

Furthermore, the method 300 includes interpreting, by an analyzing unit, the data of the impact thereby creating a plurality of patterns to diagnosing injuries from the data of impact thereby measuring the force of the impact in step 315.

Additionally, the method 300 includes analyzing, by the analyzing unit, a historical data to generate insights pertaining to the user's safety and training in step 320.

In one embodiment, the method 300 includes determining, a data processing unit, the severity and potential consequences of the impact using predetermined techniques wherein the severity is determined by a predefined threshold value.

Further, the method 300 includes detecting, by a tracking unit, an accurate location of the user via a plurality of satellite units in step 325.

The method 300 also includes sending, by a communication unit, an alert to one or more predetermined contacts of the user in step 330. The smart helmet includes a microcontroller to activate the communication unit based on severity of the impact. The microcontroller is a compact integrated circuit with a processor core, memory, and programmable peripherals, commonly used in embedded systems for specific task execution.

In one embodiment, the method 300 includes notifying, by an alert unit, the user upon detecting a material degradation of the smart helmet, wherein the material degradation is identified using a plurality of techniques.

In another embodiment, the method 300 includes indicating, by a light emitting diode unit, status of battery health, connectivity and system malfunction.

Further, the method 300 also includes storing, by a cloud connectivity unit, the data of the impact thereby allowing the authorized users to access the data of the impact by scanning a quick response code wherein the quick repose code links to the smart helmet an agnostic application facilitating data retrieval and emergency response in step 335.

It must be noted that the agnostic application is configured on the user device 255 and connects to the smart helmet 100 to provide insights beyond the emergency scenarios, for instance daily wear patterns and potential degradation of materials used in the smart helmet 100. As a pre-requisite, a user profile is created by the agnostic application. Further, the agnostic application is configured to display the health of the smart helmet 100, maintenance and impacts to the user.

In one embodiment, the method 300 includes providing, by a feedback unit 250, tactile sensations to the user in response to the one or more notifications and alerts. Further, the method 300 includes analyzing, by the feedback unit 250, historical data and real-time data of the impact from the cloud connectivity unit to generate potential insights using artificial intelligence technique as feedback pertaining to the user's safety measures wherein the historical data is the data collected from the plurality of sensors.

Additionally, the method 300 includes adapting, by a battery unit, to prevent damage to the battery unit during the impact thereby protecting against short circuits in step 340.

In one embodiment, the method 300 includes enabling self-charging of the smart helmet using solar energy.

In another embodiment, the method 300 includes integrating, by an augmented reality visor, real-time information on a display within the user's field of view thereby enhancing a riding experience.

Various embodiments of the smart helmet to capture, detect, and communicate an impact provides several benefits. The receiving module captures the data of the impact from the plurality of sensors thereby the medical professionals may easily access the data whenever required to diagnose injury. Further, after the occurrence of the impact, the data of the impact is communicated to emergency or predetermined contacts thereby saving lives of the users. Further, the location is tracked using satellite units allowing the user's location to be pinpointed quickly. Further, the data of the impact is stored thereby the medical professionals or authorized users may generate patterns to comprehend damage. Further, to access the data of the impact generated one may scan QR code using his/her user device 255 thereby easily accessing the data of the impact.

It will be appreciated to those skilled in the art that although the present disclosure provides a smart helmet to be used on the roads, the said smart helmet may also be applicable to industrial settings, sport or other reactional activities that require the user to utilize the smart helmet.

The techniques described in this disclosure may be implemented, at least in part, in hardware, software, firmware, or any combination thereof. For example, various aspects of the described techniques may be implemented within one or more processors, including one or more microprocessors, digital signal processors (DSPs), application-specific integrated circuits (ASICs), field-programmable gate arrays (FPGAs), or any other equivalent integrated or discrete logic circuitry, as well as any combinations of such components. The term “processor” or “processing subsystem” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various techniques described in this disclosure. In addition, any of the described units, modules, or components may be implemented together or separately as discrete but interoperable logic devices. Depiction of different features as modules or units is intended to highlight different functional aspects and does not necessarily imply that such modules or units must be realized by separate hardware, firmware, or software components. Rather, functionality associated with one or more modules or units may be performed by separate hardware, firmware, or software components, or integrated within common or separate hardware, firmware, or software components.

It will be understood by those skilled in the art that the foregoing general description and the following detailed description are exemplary and explanatory of the disclosure and are not intended to be restrictive thereof.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, the order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

I claim:

1. A smart helmet to capture, detect, and communicate an impact comprising:
characterized in that,
a processing subsystem hosted on a server, wherein the processing subsystem is configured to execute on a network to control bidirectional communications among a plurality of modules comprising:
a receiving unit configured to receive data of impact in real-time from a plurality of sensors in response to an impact experienced on the smart helmet utilized by a user of a vehicle,
wherein the plurality of sensors are positioned at a predetermined distance inside the smart helmet to measure force, direction, and angle of the impact to facilitate analysis of a plurality of potential injuries to the user, and
wherein the plurality of sensors are configured to communicate the data to one or more authorized users in real-time;
an analyzing unit operatively coupled to the receiving unit wherein the analyzing unit is configured to:
interpret the data of the impact by creating a plurality of patterns to diagnosing injuries from the data of impact thereby measuring the force of the impact; and
analyze historical data to generate insights pertaining to the user's safety and training;
a tracking unit operatively coupled to the analyzing unit wherein the tracking unit is configured to detect an accurate location of the user via a plurality of satellite units;
a communication unit operatively coupled to the tracking unit wherein the communication unit is configured to send an alert about the impact to one or more predetermined contacts of the user;
a cloud connectivity unit operatively coupled to the communication unit wherein the cloud connectivity unit is configured to store the data of the impact in a cloud thereby allowing one or more authorized users to access the data of the impact to understand the patterns and diagnose potential injuries; and
a battery unit operatively coupled to the cloud connectivity unit wherein the battery unit is adapted to avoid a potential damage during the impact thereby protecting against short circuits.

2. The smart helmet as claimed in claim 1, wherein the plurality of sensors comprises:
an environmental sensor configured to detect a plurality of external factors and subsequently provide real-time updates to the user;
a piezoelectric sensor configured to detect the force and direction of the impact;
an accelerometer sensor configured to measure the dynamics of the impact via multiple parameters, wherein the parameters comprises a rate of change in velocity and a plurality of acceleration forces during the impact; and
a biometric sensor configured to detect a plurality of physiological parameters of the user pertaining to health information of the user.

3. The smart helmet as claimed in claim 1, comprising a data processing unit operatively coupled to the analyzing unit wherein the data processing unit is configured to determine severity and potential consequences of the impact using predetermined techniques wherein the severity is determined by a predefined threshold value.

4. The smart helmet as claimed in claim 1, comprising:
an alert unit operatively coupled to the communication unit wherein the alert unit is configured to notify the user upon detecting a material degradation of the smart helmet, wherein the material degradation is identified using a plurality of techniques; and
a light emitting diode unit operatively coupled to the alert unit wherein the light emitting diode unit is configured to indicate status of battery health, connectivity, and system malfunction.

5. The smart helmet as claimed in claim 1, comprising a feedback unit operatively coupled to the cloud connectivity unit wherein the feedback unit is configured to:
provide tactile sensations to the user in response to the one or more notifications and alerts; and
analyze historical data and real-time data of the impact from the cloud connectivity unit to generate potential insights using artificial intelligence technique as feedback pertaining to the user's safety measures wherein the historical data is the data collected from the plurality of sensors.

6. The smart helmet as claimed in claim 1, wherein the receiving unit enables a user profile management for providing medical and personal data to be used during emergency situations.

7. The smart helmet as claimed in claim 1, comprising a microcontroller to activate the communication unit based on the severity of the impact.

8. The smart helmet as claimed in claim 1, comprising:
a plurality of cameras operatively coupled to the receiving unit and positioned at a front end, left side, right side and rear ends of the smart helmet wherein the plurality of cameras are configured to capture the impact and an environment enclosing the occurrence of the impact;
a plurality of solar photovoltaic cells configured to enable self-charging of the smart helmet using solar energy; and
an augmented reality visor configured to integrate real-time information on a display within the user's field of view thereby enhancing a riding experience.

9. The smart helmet as claimed in claim 1, wherein the tracking unit comprises a global positioning system to obtain an accurate location of the user thereby facilitating a timely and precise emergency response.

10. A method to operate the smart helmet to capture, detect, and communicate an impact comprising:
characterized in that,
receiving, by a receiving unit, data of an impact in real-time from a plurality of sensors in response to an impact experienced on the smart helmet utilized by a user of a vehicle,
wherein the plurality of sensors are positioned at a predetermined distance inside the smart helmet to measure force, direction, and angle of the impact to facilitate analysis of a plurality of potential injuries to the user;
wherein the plurality of sensors are configured to communicate the data to one or more authorized users in real-time;
interpreting, by an analyzing unit, the data of the impact by creating a plurality of patterns to diagnosing injuries from the data of impact thereby measuring the force of the impact;
analyzing, by the analyzing unit, a historical data to generate insights pertaining to the user's safety and training;
detecting, by a tracking unit, an accurate location of the user via a plurality of satellite units;
sending, by a communication unit, an alert about the impact to one or more predetermined contacts of the user;
storing, by a cloud connectivity unit, the data of the impact thereby allowing one or more authorized users to access the data of the impact to understand the patterns and diagnose potential injuries; and
adapting, by a battery unit, to avoid a potential damage to the battery unit during the impact thereby protecting against short circuits.
